(19) United States
(12) Patent Application Publication
(10) Pub. No.: US 2025/0088369 A1
(43) Pub. Date: Mar. 13, 2025

(54) SYSTEMS AND METHODS OF LAYERING SECURITY FOR CELLULAR-ENABLED BLOOD PRESSURE DATA TRANSMISSION

(71) Applicant: Smart Meter Corporation, Tampa, FL (US)

(72) Inventor: Benjamin Atkin, Bergenfield, NJ (US)

(73) Assignee: Smart Meter Corporation, Tampa, FL (US)

(21) Appl. No.: 18/963,296

(22) Filed: Nov. 27, 2024

Related U.S. Application Data
(63) Continuation-in-part of application No. 17/494,137, filed on Oct. 5, 2021.
(60) Provisional application No. 63/088,204, filed on Oct. 6, 2020.

(51) Int. Cl. H04L 9/32; H04L 12/46

(52) U.S. Cl. CPC H04L 9/3247; H04L 9/3242; H04L 12/4633; H04L 12/4641; H04L 2209/88

(57) ABSTRACT

A system for improved blood pressure data transmission security comprising: a blood pressure monitor; a wireless network connected to the monitor; a private network connected to the wireless network via an IPsec VPN tunnel; one or more computer processors; and a memory storing machine executable instructions, that when executed, cause the system to: collect, initial measurements from a patient; encrypt, the initial measurements with a shared secret, creating encrypted measurements; generate, a first hash using a signing algorithm; transmit, the encrypted measurements from the monitor to the private network; generate, a second hash; compare, the first hash to the second hash; decrypt, the encrypted measurements upon a match of the first and second hash, creating verified measurements; and transmit, the verified measurements to a target recipient.

### CROSS REFERENCE TO RELATED APPLICATIONS

The present application claims the benefit of U.S. patent application Ser. No. 17/494,137 for BLOOD PRESSURE DEVICE, filed Oct. 5, 2021, and U.S. Patent Application No. 63/088,204 for BLOOD PRESSURE DEVICE, filed Oct. 6, 2020, the entire contents of which are incorporated herein by reference.

### FIELD OF THE INVENTION

The present disclosure is directed to an electronic blood pressure device. More specifically, the present disclosure is directed to an electronic blood pressure device and of layering security for cellular-enabled blood pressure data transmission.

### INTRODUCTION

Hypertension is a prevalent health concern in the United States, that affects millions of individuals. According to the Centers for Disease Control and Prevention's (CDC) “Facts About Hypertension,” nearly half of all adults in the United States are stricken with hypertension, making it a significant public health issue.¹ Despite its prevalence, hypertension often goes undiagnosed and untreated, which can lead to serious health complications, such as, aneurysms, heart attacks, and strokes. ¹https://www.cdc.gov/bloodpressure/facts.htm

Regularly tracking blood pressure is of paramount importance in the prevention of the aforementioned complications because hypertension is often asymptomatic. Meaning, people afflicted with hypertension are often unaware until a serious complication arises. As such, monitoring blood pressure at regular intervals enables individuals to detect high blood pressure early, thus allowing them to take preventive action to mitigate the risks associated with complications. Moreover, blood pressure monitoring is crucial for assessing the efficacy of both lifestyle modifications and medication in lowering one's blood pressure. Therefore, monitoring blood pressure allows individuals and healthcare providers to track progress and make necessary adjustments to treatment plans.

As it stands, the most common ways of monitoring blood pressure is via regular visits to healthcare providers, self-monitoring of blood pressure at home using validated devices, and community-based screening programs. However, regularly travelling to and from facilities is time consuming and a drain on economic resources. Further, current at home blood pressure monitors, while convenient, are often not intuitive, rendering them difficult for use without assistance.

Accordingly, it would be desirable to provide a blood pressure device that eliminates the need to travel to regularly monitor blood pressure. Additionally, it would be desirable to provide a blood pressure device that is user-friendly. Therefore, it would be desirable to provide the blood pressure device of the present disclosure.

### SUMMARY

Bearing in mind the problems and deficiencies of the prior art, it is therefore an object of the present disclosure to provide a process and system for social interaction and community building.

Aspects of the present disclosure relate to a system for improving the security of cellular-enabled blood pressure data transmission by layering security. The system being comprised of an electronic blood pressure monitor; a wireless network connected to the electronic blood pressure monitor; a private network connected to the wireless network via a persistent and fully redundant Internet Protocol Security (IPsec) Virtual Private Network (VPN) tunnel; one or more computer processors; and a memory having stored therein machine executable instructions, that when executed by the one or more processors, cause the system to: collect, via the electronic blood pressure monitor, initial blood pressure measurements from a patient; encrypt, via the electronic blood pressure monitor, the initial blood pressure measurements with a shared secret, wherein encrypting the initial blood pressure measurements creates encrypted blood pressure measurements; generate, via the electronic blood pressure monitor, a first hash using a signing algorithm; transmit, via the persistent and fully redundant IPsec VPN tunnel, the encrypted blood pressure measurements from the electronic blood pressure monitor to the private network; generate, via the private network, a second hash; compare, via the one or more computer processors, the first hash to the second hash; decrypt, via the one or more computer processors, the encrypted blood pressure measurements upon a match of the first and second hash, wherein decrypting the encrypted blood pressure measurements creates verified blood pressure measurements; and transmit, via the one or more computer processors, the verified blood pressure measurements to a target recipient.

Aspects of the present disclosure relate to a system wherein the shared secret is a symmetric-key algorithm comprising: a key; and a symmetric block cipher. In an embodiment, the key is comprised of at least one of a 128-bit key, a 256-bit key, a 576-bit key, and a 2040-bit key. In a further embodiment, the symmetric block cipher is comprised of at least one of an Advanced Encryption Standard (AES) block cipher, a Blowfish block cipher, a CAST-256 block cipher, a GOST block cipher, an International Data Encryption Algorithm (IDEA) block cipher, a Rivest Cipher 6 (RC-6) block cipher, a Serpent block cipher, and a Twofish block cipher. In yet a further embodiment, the persistent and fully redundant IPsec VPN tunnel leverages the symmetric-key algorithm to encrypt the encrypted blood pressure measurements while travelling through the persistent and fully redundant IPsec VPN tunnel.

Aspects of the present disclosure relate to a system wherein the cellular modem connects to the wireless network via an Access Point Name (APN).

Aspects of the present disclosure relate to a system wherein the persistent and fully redundant IPsec VPN tunnel is further comprised of Transport Layer Security (TLS).

Aspects of the present disclosure relate to a system wherein the verified blood pressure measurements are transmitted to one or more client devices of the target recipient.

Aspects of the present disclosure relate to a system wherein the signing algorithm is comprised of at least one of Rivest-Shamir-Adleman (RSA) algorithms, EIGamal signature scheme, Digital Signing Algorithm (DSA), and Elliptical Curve Digital Signature Algorithm (ECDSA).

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 illustrates an embodiment of an environment in which the present disclosure may be practiced;

FIG. 2 illustrates an embodiment of a block diagram of an electronic device;

FIG. 3 is an illustration of an embodiment of an electronic blood pressure monitor;

FIG. 4 is an illustration of an embodiment of a method for collecting blood pressure measurements of a patient;

FIG. 5 is an illustration of an embodiment of a system of layering security for cellular-enabled blood pressure data transmission; and

FIG. 6 is an illustration of an embodiment of a method of layering security for cellular-enabled blood pressure data transmission.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

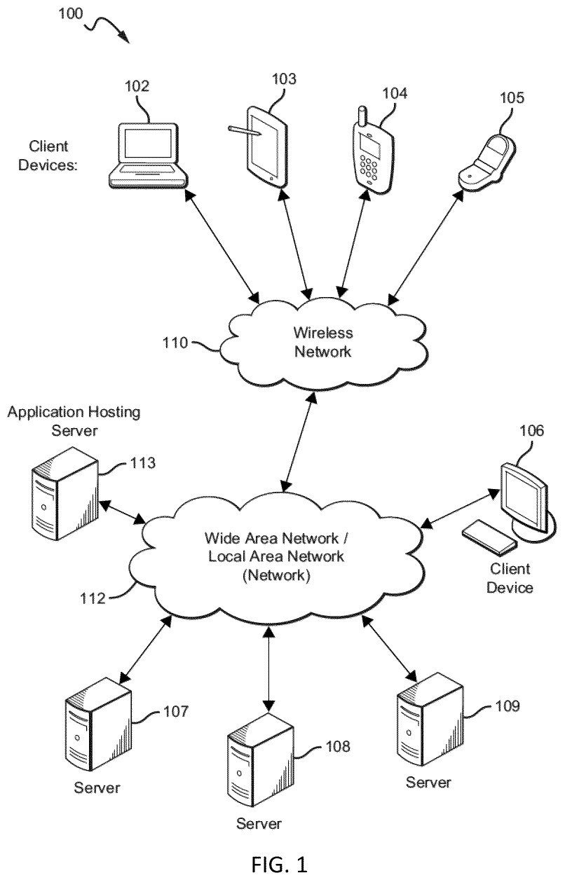

FIG. 1 illustrates components of one embodiment of an environment in which the present disclosure may be practiced. Not all of the components may be required to practice the present disclosure, and variations in the arrangement and type of the components may be made without departing from the spirit or scope of the present disclosure. As shown, the system 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. The client devices 102-106 may include, for example, at least one of desktop computers, laptop computers, set top boxes, tablets, cell phones, smart phones, smart speakers, wearable devices (such as the Apple Watch) and the like. Servers 107-109 can include, for example, one or more application servers, content servers, search servers, and the like. FIG. 1 also illustrates application hosting server 113.

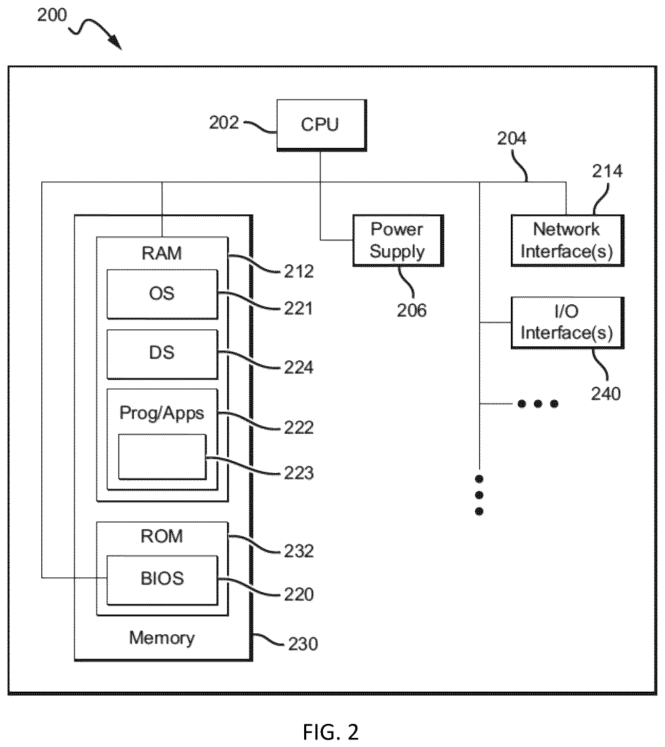

FIG. 2 illustrates a block diagram of an electronic device 200 that can implement one or more aspects of an apparatus, system and method for validating and correcting user information (the “Engine”) according to one embodiment of the present disclosure. Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software and other tools necessary to implement or facilitate methods and systems according to embodiments of the present disclosure. The elements may exist on a single computer or be distributed among multiple computers, servers, devices or entities.

The power supply 206 contains one or more power components and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server may, for example, host a web site that can provide a user interface for administration of example aspects of the Engine.

Any computing device capable of sending, receiving, and processing data over a wired and/or a wireless network may act as a server, such as in facilitating aspects of implementations of the Engine. Thus, devices acting as a server may include devices such as dedicated rack- mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system and method of the Engine. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third- party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the Engine. Content may include, for example, text, images, audio, video, and the like.

In example aspects of the apparatus, system and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system and method embodying the Engine, may range widely in terms of capabilities and features. For example, a cell phone, smart phone or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices 102-106, for example, as may be used in an example apparatus, system and method implementing the Engine, may run a variety of operating systems, including personal computer operating systems such as Windows, iOS or Linux, and mobile operating systems such as iOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, system and method implementing the Engine, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system and method implementing the Engine, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, and the like. Access technologies such as 2G, 2.5G, 3G, 4G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the Engine, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present disclosure include apparatuses, systems, and methods implementing the Engine. Embodiments of the present disclosure may be implemented on one or more of client devices 102-106, which are communicatively coupled to servers including servers 107-109. Moreover, client devices 102-106 may be communicatively (wirelessly or wired) coupled to one another. In particular, software aspects of the Engine may be implemented in the program 223. The program 223 may be implemented on one or more client devices 102-106, one or more servers 107-109, and 113, or a combination of one or more client devices 102-106, and one or more servers 107-109 and 113.

In an embodiment, the system may receive, process, generate and/or store time series data. The system may include an application programming interface (API). The API may include an API subsystem. The API subsystem may allow a data source to access data. The API subsystem may allow a third-party data source to send the data. In one example, the third-party data source may send JavaScript Object Notation (“JSON”)-encoded object data. In an embodiment, the object data may be encoded as XML-encoded object data, query parameter encoded object data, or byte-encoded object data.

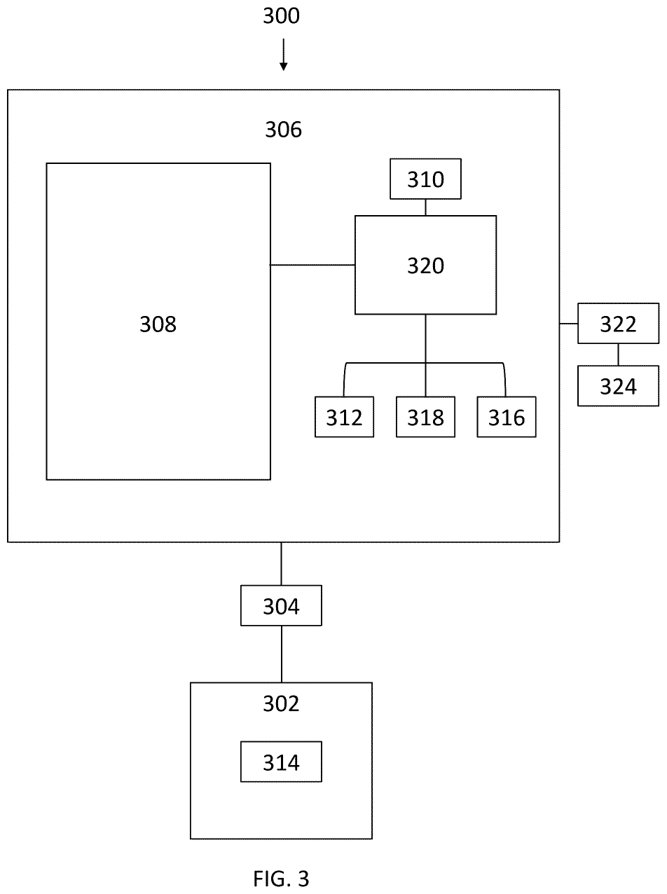

FIG. 3 depicts a block diagram of an electronic blood pressure monitor 300. The electronic blood pressure monitor 300 includes at least one of a cuff 302, a tube 304, and a main body 306.

In an embodiment, the cuff 302 may be fitted to a patient 504. Moreover, said cuff 302 may be pressurized via air pressure delivered from the main body 506 through the tube 304. In such an embodiment, the tube 304 may be disposed between the cuff 302 and the main body 306, wherein the tube 304 connects the main body 306 to the cuff 302, or vice versa.

The electronic blood pressure monitor 300 may be configured to take initial blood pressure measurements (i.e., a systolic blood pressure value, a diastolic blood pressure value, and a pulse rate) of the patient 504, wherein the display 308 may be configured to present a visual depiction of the initial blood pressure measurements 502. Additionally, the electronic blood pressure monitor 300 may be further comprised of a memory 310, wherein said memory 310 may be configured to store the initial blood pressure measurements 502. In an embodiment, the electronic blood pressure monitor 300 may be manipulated to recall the initial blood pressure measurements 502, stored within the memory 310, that were collected for a particular patient.

Moreover, the electronic blood pressure monitor 300 may include a pressure sensor 312, disposed within the main body 306. In an embodiment, the pressure sensor 312 may output a change in a pulse pressure of the patient 504 detected via an air bag 314 disposed within the cuff 302 as a pulse wave signal. In another embodiment, the electronic blood pressure monitor 300 may further comprise a pump 316 and/or a valve 318, which are configured to adjust an air pressure level within the air bag 314. In an embodiment, at least one of the pump 316 and the valve 318 may be disposed within the main body 306. Moreover, the air bag 314 may be connected to at least one of the pressure sensor 312, the pump 316, and the valve 318 via the tube 304.

The electronic blood pressure monitor 300 may additionally include an external data processing unit 322. For example, a CPU 320, disposed within the main body 306, may transmit the initial blood pressure measurements 502 to the external data processing unit 322. Moreover, in some examples, the external data processing unit 322 may be cellular enabled and, in some examples, may incorporate SMC cellular patented technology, among other technologies not explicitly listed herein.

Specifically, in an embodiment, the external data processing unit 322 may be comprised of a cellular modem 324, wherein said modem 324 is able to communicate and/or transmit at least one of the initial blood pressure measurements 502 and the encrypted blood pressure measurements 506 to one or more of the client devices 102-106. It should be appreciated that, as described herein, the cellular modem 324 is a device that adds cellular connectivity to devices such as, laptops, desktop computers, tablets, etc. Furthermore, it should be appreciated that the cellular modem 324 may replace existing BLE modules in Bluetooth enabled devices as described herein.

In a further embodiment, the cellular modem 324 may be embedded within the external data processing unit 322 and/or a standalone device connected to the external data processing unit 322. The connection between the external data processing unit 322 and the cellular modem 324 may be achieved via, a USB connection. As a nonlimiting example, the cellular modem 324 may be selected from the group consisting of AT&T Momentum, Verizon 551 L, USB cellular modems, and motherboard mounted cellular chipsets manufactured by Novatel Wireless, Sierra Wireless, Huawei, and the like. In a further nonlimiting example, the cellular modem 324 may operate by switching between cellular and satellite communications.

Furthermore, the cellular modem 324 may be configured to automatically connect to a slower network when the faster network is not available. The cellular modem 324 may also monitor the reliability of all available connections. The reliability of a network (e.g., the wireless network 110) may be determined from information collected by the cellular modem 324, which includes, but is not limited to, signal strength, quality, availability, packet loss, retransmits, packet latency, throughput speed, and other cell tower signaling quality factors. The cellular modem 324 may then compare the aforementioned information to a reliability threshold for determining whether to maintain or terminate a connection to the network. The reliability threshold is often automatically set by a cellular carrier or may be manually set by the user of the external data processing unit 322.

Further, it should be appreciated that the cellular modem 324 is also configured to establish a connection with cellular networks in which the cellular modem 324 is located. The cellular modem 324 may be configured to monitor and detect all cellular networks, comprising the wireless network 110, as the cellular modem 324 moves from one network coverage area to another network coverage area. The cellular modem 324 may detect when a connection to the wireless network 110 is made. For example, the cellular modem 324 may detect whether the wireless network 110 is a 3G, 4G, or 5G network, as well as which cellular network provider (e.g., AT&T, T-Mobile, Verizon, etc.) the modem 324 has connected to.

As described herein, “systolic blood pressure” measures the force of blood against a patient's artery walls while said patient's ventricles squeeze and push blood out to the rest of the patient's body. For a typical adult, the systolic blood pressure is normally less than 140 mmHg.

As described herein, the “diastolic blood pressure measures the force of blood against the patient's artery walls as the individual's heart relaxes and the ventricles are allowed to refill with blood. Diastole, the period of time when the individual's heart relaxes between beats, is also the time that the patient's coronary artery is able to supply blood to the heart. For a healthy adult, the diastolic blood pressure is normally less than 90 mm Hg.

As defined herein, the “pulse rate” is the number of heartbeats of the patient per minute. The resting pulse rate for an average adult is between 60 and 80 beats per minute. It should be appreciated that the electronic blood pressure monitor 300 may perform a self-calibration test. Accuracy of the blood pressure measurements may depend upon the “exhaust velocity”, or deflation rate, of the cuff 302. In an embodiment, the electronic blood pressure monitor 300 may be configured to operate with a deflation rate of 2 to 3 mm Hg per step, as recommended by the American Heart Association (AHA). See, Liz Smith, “New AHA Recommendations for Blood Pressure Measurement,” Am Fam Physician, 2005, 72(7), Pages 1391-1398, the contents of which are hereby incorporated by reference in its entirety.

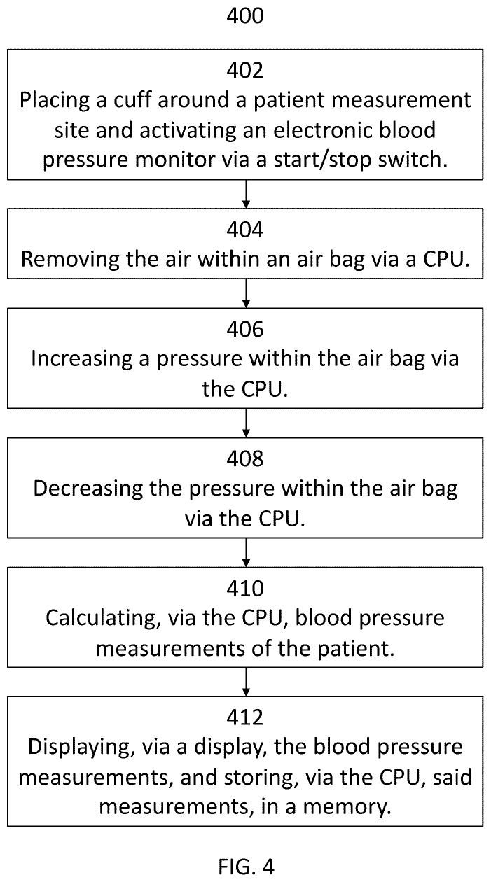

Turning to FIG. 4, a block diagram of a method for collecting the blood pressure measurements of the patient 400 is depicted. It should be appreciated that the steps comprising the method for collecting the blood pressure measurements of the patient 400 may be pre-stored in the memory 310 as a program and are read and executed by the CPU 320 disposed within the main body 306. Said method for collecting the blood pressure measurements of the patient 400 may include a first step 402, wherein the patient 504 places the cuff 302 around a measurement site (e.g., the upper arm, the wrist, and/or the finger of the user/subject). Upon placement of the cuff 302 in the first step 402, the patient 504 may activate the electronic blood pressure monitor 300 via a start/stop switch (not depicted). In response to said activation, a signal may be applied to the CPU 320, wherein the CPU 320, may supply power to the electronic blood pressure monitor 300.

Furthermore, the method for collecting the blood pressure measurements of the patient 400 may be further comprised of a second step 404, wherein the CPU 320 removes air within the air bag 314 such that an output level of the pressure sensor 312 is 0 mmHg.

The method 400, may include a third step 406, wherein the pressure within air bag 314 is increased, via the CPU 320, such that the systolic blood pressure of the patient is equal to or greater than 40 mmHg.

A fourth step 408 of the method 400 may gradually decrease the pressure within air bag 314, via the CPU 320. During the fourth step 408, the pressure within the air bag 314 is detected by the pressure sensor 312.

In a fifth step 410 of the method 400, the CPU 320 may calculate the initial blood pressure measurements 502 of the patient 504 based on the detected pressure.

It should be appreciated that the method 400 may measure the systolic blood pressure value, the diastolic blood pressure value, and/or the pulse rate of the patient via a pressure-increasing process. In further examples, the systolic blood pressure value, the diastolic blood pressure value, and the pulse rate of the patient may be calculated as an average based on numerous factors and conditions. For example, the systolic blood pressure value for the patient may be calculated as an average for a week's time. In another example, the diastolic blood pressure value for the user/subject may be calculated as an average for every morning (e.g., between 4:00 AM-10:00 AM) for a month's time. Moreover, the CPU 320 may temporarily store the systolic blood pressure value, the diastolic blood pressure value, and the pulse rate of the patient in an internal memory of the CPU 320.

The method for collecting the blood pressure measurements of the patient 400 may be further comprised of a sixth step 412, wherein the electronic blood pressure monitor 300 displays, via the display 308, the initial blood pressure measurements 502 of the patient 504. In said sixth step 412, the CPU 320 may read the initial blood pressure measurements 502 of the patient 504 and store said measurements 502 in the memory 310.

In an example, the electronic blood pressure monitor 300 may store the initial blood pressure measurements 502 for two or more patients.

In an embodiment, the initial blood pressure measurements 502 of the two or more patients who have measurements taken by the electronic blood pressure monitor 300 may be associated with a unique identifier stored in the memory 310. In a further embodiment, the unique identifier may be associated with the initial blood pressure measurements 502 for one of the two or more patients.

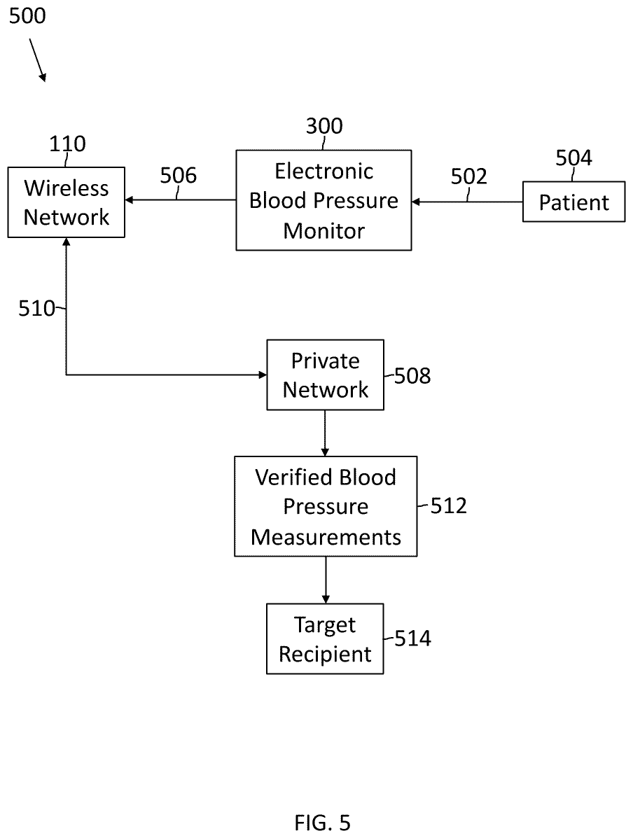

Referring to FIG. 5, the systems and methods of layering security for cellular-enabled blood pressure data transmission (the “system”) 500 may include the electronic blood pressure monitor 300.

In an embodiment, electronic blood pressure monitor 300 collects initial blood pressure measurements (i.e., the systolic blood pressure value, the diastolic blood pressure value, and the pulse rate) 502 from the patient 504 via the method for collecting the blood pressure measurements of the patient 400. Further, the electronic blood pressure monitor 300 may utilize various transmission protocol means, such as, but not limited to USSD message transmission technology, CMDA, SMS, GSM, and/or GPRS technology. Through said transmission protocols, at least one of messages and the initial blood pressure measurements 502 may be transmitted to a central database where said messages and measurements 502 are stored.

Upon collection of the initial blood pressure measurements 502, the electronic blood pressure monitor 300 may encrypt said measurements 502, thus transforming the initial blood pressure measurements 502 into encrypted blood pressure measurements 506. In an embodiment, the electronic blood pressure monitor 300 may encrypt the initial blood pressure measurements 502 with a shared secret.

In one embodiment, the shared secret may consist of a specific piece of data, such as a Personal Identification Number (PIN) or password. The shared secret may enable two or more parties to securely exchange information. Specifically, after encrypted information is exchanged, the shared secret may enable the parties to decrypt the information, ensuring that only those with access to the shared secret can access the content.

In another embodiment, the shared secret may be shared prior to transmission of the encrypted blood pressure measurements 506 and/or created at the start of transmission of the measurements 506. In a nonlimiting example, if the shared secret is shared prior to the transmission, the shared secret may be referred to as a pre-shared key. As a further nonlimiting example, the shared secret, may be created at the start of the transmission with a key-agreement protocol. In yet a further nonlimiting example, the shared secret may be at least one of an asymmetric-key algorithm and a symmetric-key algorithm.

In an embodiment, the symmetric-key algorithm may utilize a key to convert the initial blood pressure measurements 502 into the encrypted blood pressure measurements 506. In a nonlimiting example, the symmetric-key algorithm may be comprised of at least one of a key and a symmetric block cipher. In a further embodiment, the key may be at least one of a 128-bit key, a 256-bit key, a 576-bit key, and a 2040-bit key. However, any suitable size bit key alternative may comprise the key. In yet another embodiment, the symmetric block cipher may be comprised of at least one of an Advanced Encryption Standard (AES) block cipher, a Blowfish block cipher, a CAST-256 block cipher, a GOST block cipher, an International Data Encryption Algorithm (IDEA) block cipher, a Rivest Cipher 6 (RC-6) block cipher, a Serpent block cipher, and a Twofish block cipher. However, any suitable symmetric block cipher alternative may be utilized.

Additionally, upon creation of the encrypted blood pressure measurements 506, the electronic blood pressure monitor 300 may sign said measurements 506 via a signing algorithm, thus creating a data signature. For example, the encrypted blood pressure measurements 506 may be cryptographically signed. The encrypted blood pressure measurements 506 may be signed via a signing algorithm, which may include at least one of Rivest-Shamir-Adleman (RSA) algorithms, EIGamal signature scheme, Digital Signing Algorithm (DSA), and Elliptical Curve Digital Signature Algorithm (ECDSA). For example, the signing algorithm generates a first hash to accompany the encrypted blood pressure measurements 506.

Further, the electronic blood pressure monitor 300 may connect to the wireless network 110. In an embodiment, the electronic blood pressure monitor 300 may connect to the wireless network 110 via the external data processing unit 322. For example, the cellular modem 324, embedded within the external data processing unit 322, may connect to the wireless network 110. In another example, the cellular modem 324 may connect to the external data processing unit 322 via a USB cable. Such a connection to the wireless network 110 may be achieved via an Access Point Name (APN). As a nonlimiting example, the APN may be a private APN. In an additional embodiment, the APN may require the client devices 102-106 and/or the electronic blood pressure monitor 300 to be authorized prior to accessing the wireless network 110. The authorization may register the client devices 102-106 and/or the electronic blood pressure monitor 300 via a computing device identifier. The computing device identifier may be at least one of a Subscriber Identification Module (SIM), an International Mobile Equipment Identity (IMEI), and an Integrated Circuit Card Identification Number (IICID).

After the electronic blood pressure monitor 300 connects to the wireless network 110, the encrypted blood pressure measurements 506 may be transmitted. For example, the encrypted blood pressure measurements 506 may be transmitted to a private network 508. In an embodiment, the encrypted blood pressure measurements 506 may be transmitted from the wireless network 110 to the private network 508 via a tunnel 510. For example, the tunnel 510 may connect the wireless network 110 to the private network 508, such that the encrypted blood pressure measurements 506 may travel from the wireless network 110 to the private network 508, or vice versa. As a nonlimiting example, the tunnel 510 may be a persistent and fully redundant Internet Protocol Security (IPsec) Virtual Private Network (VPN) tunnel. Moreover, the tunnel 510 may leverage the symmetric-key algorithm to encrypt and protect the encrypted blood pressure measurements 506 while traveling through the tunnel 510. In another embodiment, the tunnel 510 may also utilize Transport Layer Security (TLS) as another form of protection for transmitting the encrypted blood pressure measurements 506 through the tunnel 510.

Further, once the encrypted blood pressure measurements 506 have travelled through the tunnel 510, said measurements 506 may be received by the private network 508. In an embodiment, the system 500 may generate an acknowledgment that is sent to the electronic blood pressure monitor 300 upon acceptance of the encrypted blood pressure measurements 506 by the private network 508.

Upon receipt of the encrypted blood pressure measurements 506, the private network 508 may verify the data signature of said measurements 506. For example, the private network 508 may compute a second hash at ingest of the encrypted blood pressure measurements 506. Moreover, the second hash may be compared with the first hash. If said first and second hash are a match, then the private network 508 may accept the encrypted blood pressure measurements 506, thus verifying the authenticity of said measurements 506. If the first and second hash are not a match the private network 1508 may reject the encrypted blood pressure measurement 506, thus ensuring the measurements 506 comes from a verified source.

Additionally, the private network 508 may decrypt the encrypted blood pressure measurements 506 after verifying the first hash and the second hash are a match, thus transforming said measurements 506 into verified blood pressure measurements 512. The verified blood pressure measurements 512 may then be quality controlled and/or stored. Further, the verified blood pressure measurements 512 may be transmitted to a target recipient 514. In such an embodiment, the verified blood pressure measurements 512 may be transmitted to one or more of the client devices 102-106 of the target recipient 514. In a further embodiment, the target recipient 514 may be the patient 504 whom the verified blood pressure measurements 512 corresponds to. In another embodiment, the target recipient 514 may be a healthcare provider (e.g., a physician, a nurse, etc.) for the patient 504.

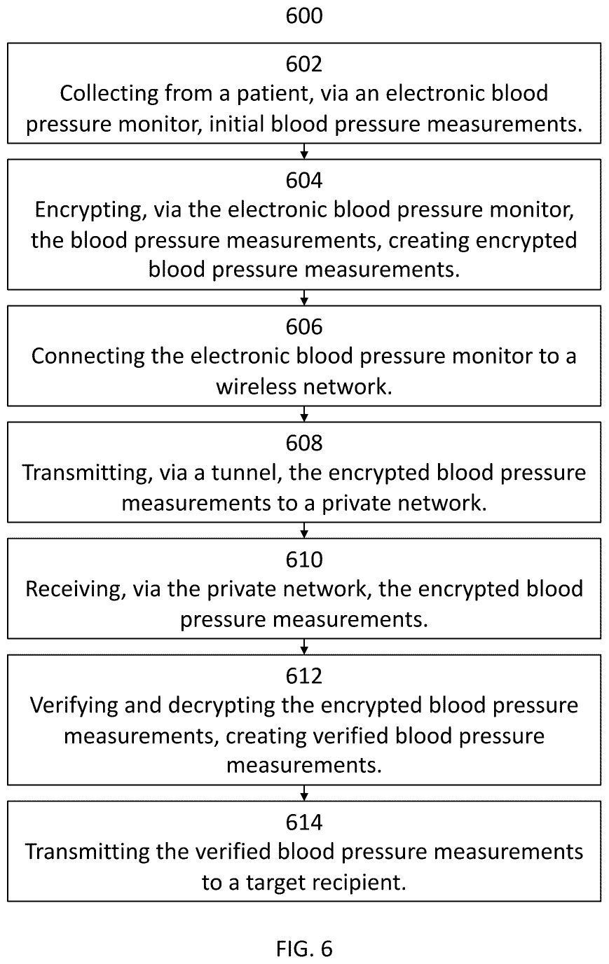

Turning to FIG. 6, a method of layering security for cellular-enabled blood pressure data transmission (the “method”) 600 may be comprised of at least a first step 602.

In the first step 602, the electronic blood pressure monitor 300 may collect the initial blood pressure measurements 502 from the patient 504 via the method for collecting the blood pressure measurements of the patient 400.

In a second step 604 of the method 600, after collecting the initial blood pressure measurements 502 from the patient 504, the electronic blood pressure monitor 300 may encrypt, and sign said measurements 502, thus transforming it into encrypted blood pressure measurements 506. In an embodiment, the electronic blood pressure monitor 300 may encrypt the initial blood pressure measurements 502 with the shared secret, wherein the shared secret may be the symmetric-key algorithm. In another embodiment, the symmetric-key algorithm may be comprised of the key and the symmetric block cipher. For example, the symmetric block cipher may be AES-256. Moreover, the encrypted blood pressure measurements 506 may be signed via the signing algorithm, wherein the first hash is created.

The method 600 may be further comprised of a third step 606, wherein the electronic blood pressure monitor 300 may connect to the wireless network 110. In an embodiment, the connection may be achieved via the APN.

Additionally, a fourth step 608 may be employed, wherein the encrypted blood pressure measurements 506 are transmitted to the private network 508 from the electronic blood pressure monitor 300 via the tunnel 510. In an embodiment, the encrypted blood pressure measurements 506 may first be transmitted from the electronic blood pressure monitor 300 to the wireless network 110, and then from the wireless network 110 to the private network 508 via the tunnel 510. In another embodiment, the tunnel 510 may be a persistent and fully redundant IPsec VPN tunnel. Furthermore, the tunnel 510 may also leverage TLS, as an additional form of protection for transmitting the encrypted blood pressure measurements 506 through the tunnel 510.

A fifth step 610 of the method 600 may entail the private network 508 receiving the encrypted blood pressure measurements 506. In an embodiment, upon receipt of the encrypted blood pressure measurements 506, the private network 508 may transmit an acknowledgment to the electronic blood pressure monitor 300.

Furthermore, a sixth step 612 of the method 600 may verify and decrypt the encrypted blood pressure measurements 506. The verification and decryption of the encrypted blood pressure measurements 506 may transform said measurements 506 into verified blood pressure measurements 512. In such a step 612, the second hash may be generated upon receipt of the encrypted blood pressure measurements 506, wherein said second hash is then compared to the first hash. Such a comparison may act as a verification of the source of encrypted blood pressure measurements 506.

The method 600 may further include a seventh step 614, wherein the verified blood pressure measurements 512 are quality controlled and/or relayed to the target recipient 514. In an embodiment, the target recipient 514 may be the patient 504 whom the verified blood pressure measurements 512 corresponds to and/or a healthcare provider (e.g., a physician, a nurse, etc.) for the patient 504.

As described herein, “NFC” is a set of communication protocols for communication between two electronic devices over a distance of 4 cm or less. NFC devices can act as electronic identity documents and keycards and may be used in contactless payment systems and allow mobile payment replacing or supplementing systems such as credit cards and electronic ticket smart cards. NFC can be used for sharing small files such as contacts and bootstrapping fast connections to share larger media such as photos, videos, and other files.

In an embodiment, at least one of the system 500 and the method 600 may aid in the prevention of a data breach via a cyberattack. For example, layering two or more of: (1) encrypting the initial blood pressure measurements 502; (2) connecting the electronic blood pressure monitor 300 to the wireless network 110 via the APN; (3) transmitting the encrypted blood pressure measurements 506 from the wireless network 110 to the private network 508 via the tunnel 510; (4) generating the acknowledgement and sending it to the electronic blood pressure monitor 300 upon the private network's 508 acceptance of the encrypted blood pressure measurements 506; (5) verifying the data signature of the encrypted blood pressure measurements 506 and decrypting said measurements 506; and (6) enabling the target recipient to authenticate the sender of the verified blood pressure measurements 512 may safeguard remote data transmissions of protected healthcare information from cellular-enabled devices. As a nonlimiting example, layering 1, 2, and 3 above ensures that layer 2 reinforces layer 1 and that layer 3 reinforces layer 2. The redundancy in layering security measures creates a tamper proof system for transmitting protected healthcare information. Moreover, the industry at large utilizes the public Internet to transmit information without providing origin authentication. However, both the system 500 and method 600 are able to guarantee the origin and authenticity of protected healthcare information by sending encrypted healthcare information through the tunnel 510 from the wireless network 110 to the private network 508 and requiring a comparison and match of the first and second hashes. The aforementioned layering ensures protected healthcare information (i.e., the initial 502, encrypted 506, and verified blood pressure measurements 512) reaches the target recipient 514, while simultaneously proscribing bad actors from accessing said protected information.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A system for improving security of cellular-enabled blood pressure data transmission by layering security, the system comprising:
an electronic blood pressure monitor;
a wireless network connected to the electronic blood pressure monitor;
a private network connected to the wireless network via a persistent and fully redundant Internet Protocol Security (IPsec) Virtual Private Network (VPN) tunnel;
one or more computer processors; and
a memory having stored therein machine executable instructions, that when executed by the one or more processors, cause the system to:
collect, via the electronic blood pressure monitor, initial blood pressure measurements from a patient;
encrypt, via the electronic blood pressure monitor, the initial blood pressure measurements with a shared secret,
wherein encrypting the initial blood pressure measurements creates encrypted blood pressure measurements;
generate, via the electronic blood pressure monitor, a first hash using a signing algorithm;
transmit, via the persistent and fully redundant IPsec VPN tunnel, the encrypted blood pressure measurements from the electronic blood pressure monitor to the private network;
generate, via the private network, a second hash;
compare, via the one or more computer processors, the first hash to the second hash;
decrypt, via the one or more computer processors, the encrypted blood pressure measurements upon a match of the first and second hash,
wherein decrypting the encrypted blood pressure measurements creates verified blood pressure measurements; and
transmit, via the one or more computer processors, the verified blood pressure measurements to a target recipient.

2. The system of claim 1, wherein the shared secret is a symmetric-key algorithm comprising:
a key; and
a symmetric block cipher.

3. The system of claim 2, wherein the key is comprised of at least one of a 128-bit key, a 256-bit key, a 576-bit key, and a 2040-bit key.

4. The system of claim 2, wherein the symmetric block cipher is comprised of at least one of an Advanced Encryption Standard (AES) block cipher, a Blowfish block cipher, a CAST-256 block cipher, a GOST block cipher, an International Data Encryption Algorithm (IDEA) block cipher, a Rivest Cipher 6 (RC-6) block cipher, a Serpent block cipher, and a Twofish block cipher.

5. The system of claim 2, wherein the persistent and fully redundant IPsec VPN tunnel leverages the symmetric-key algorithm to encrypt the encrypted blood pressure measurements while travelling through the persistent and fully redundant IPsec VPN tunnel.

6. The system of claim 1, wherein the electronic blood pressure monitor connects to the wireless network via an Access Point Name (APN).

7. The system of claim 1, wherein the persistent and fully redundant IPsec VPN tunnel is further comprised of Transport Layer Security (TLS).

8. The system of claim 1, wherein the verified blood pressure measurements are transmitted to one or more client devices of the target recipient.

9. The system of claim 1, wherein the signing algorithm is comprised of at least one of Rivest-Shamir-Adleman (RSA) algorithms, EIGamal signature scheme, Digital Signing Algorithm (DSA), and Elliptical Curve Digital Signature Algorithm (ECDSA).

10. A method for improving security of cellular-enabled blood pressure data transmission by layering security, the method comprising:
collecting, via an electronic blood pressure monitor, initial blood pressure measurements from a patient;
encrypting, via a shared secret generated by the electronic blood pressure monitor, the initial blood pressure measurements,
wherein encrypting the initial blood pressure measurements creates encrypted blood pressure measurements;
signing, via a signing algorithm, the encrypted blood pressure measurements, creating a first hash;
connecting, via an Access Point Name (APN), the electronic blood pressure monitor to a wireless network,
transmitting, via a persistent and fully redundant Internet Protocol Security (IPsec) Virtual Private Network (VPN) tunnel, the encrypted blood pressure measurements from the electronic blood pressure monitor to a private network;
receiving, via the private network, the encrypted blood pressure measurements,
wherein upon receipt of the encrypted blood pressure measurements, the private network generates a second hash;
verifying, via a comparison of the first hash to the second hash, the encrypted blood pressure measurements,
wherein upon a match of the first hash and the second hash, the private network decrypts the encrypted blood pressure measurements, creating verified blood pressure measurements; and
transmitting the verified blood pressure measurements to a target recipient.

11. The method of claim 10, wherein the shared secret is a symmetric-key algorithm comprising:
a key; and
a symmetric block cipher.

12. The method of claim 11, wherein the key is comprised of at least one of a 128-bit key, a 256-bit key, a 576-bit key, and a 2040-bit key.

13. The method of claim 11, wherein the symmetric block cipher is comprised of at least one of an Advanced Encryption Standard (AES) block cipher, a Blowfish block cipher, a CAST-256 block cipher, a GOST block cipher, an International Data Encryption Algorithm (IDEA) block cipher, a Rivest Cipher 6 (RC-6) block cipher, a Serpent block cipher, and a Twofish block cipher.

14. The method of claim 11, wherein the persistent and fully redundant IPsec VPN tunnel leverages the symmetric-key algorithm to encrypt the encrypted blood pressure measurements while travelling through the persistent and fully redundant IPsec VPN tunnel.

15. The method of claim 10, wherein the persistent and fully redundant IPsec VPN tunnel is further comprised of Transport Layer Security (TLS).

16. The method of claim 10, wherein the signing algorithm is comprised of at least one of Rivest-Shamir-Adleman (RSA) algorithms, EIGamal signature scheme, Digital Signing Algorithm (DSA), and Elliptical Curve Digital Signature Algorithm (ECDSA).
